(19) United States
(12) Patent Application Publication
(10) Pub. No.: US 2011/0019685 A1
(43) Pub. Date: Jan. 27, 2011

(54) METHOD AND SYSTEM FOR PACKET PREEMPTION FOR LOW LATENCY

(76) Inventors: Wael William Diab, San Francisco, CA (US); Michael Johas Teener, Santa Cruz, CA (US); Bruce Currivan, Dove Canyon, CA (US); Jeyhan Karaoguz, Irvine, CA (US); Yong Kim, San Jose, CA (US); Kenneth Ma, Cupertino, CA (US)

Correspondence Address: MCANDREWS HELD & MALLOY, LTD, 500 WEST MADISON STREET, SUITE 3400, CHICAGO, IL, 60661, US

(21) Appl. No.: 12/604,968

(22) Filed: Oct. 23, 2009

Related U.S. Application Data
(60) Provisional application No. 61/228,368, filed on Jul. 24, 2009.

(51) Int. Cl. H04L 12/56

(52) U.S. Cl. 370/412

(57) ABSTRACT

Latency requirements for Ethernet link partners comprising PHY devices and memory buffers, may be determined for packets pending transmission. Transmission may be interrupted for a first packet having greater latency than a second packet, and the second packet may be transmitted. The second packet may be interrupted for transmission of a third or more packets. Packets are inspected for marks and/or for OSI layer 2 or higher OSI layer information to determine the latency requirements prior to completion of transmission of the first packet. The second packet is transmitted after a first portion of the first packet and/or prior to a second portion. Delimiters are inserted among the first and/or second packets for interrupting transmission. A PHY layer, MAC layer and/or higher OSI layer of the second link partner may receive, buffer and/or parse the packets and/or packet portions and/or may reconstruct the first packet and/or the second packet.

### CROSS-REFERENCE TO RELATED APPLICATIONS/INCORPORATION BY REFERENCE

This application makes reference to, claims priority to, and claims the benefit of U.S. Provisional Application Ser. No. 61/228,368, filed on Jul. 24, 2009.

This patent application makes reference to:

U.S. patent application Ser. No. 12/571,147, filed on Sep. 30, 2009; and
U.S. patent application Ser. No. ______ (Attorney Docket No. 20385US01), filed on ______.

Each of the above stated applications is hereby incorporated herein by reference in its entirety.

### FIELD OF THE INVENTION

Certain embodiments of the invention relate to networking. More specifically, certain embodiments of the invention relate to a method and system for packet preemption for low latency.

### BACKGROUND OF THE INVENTION

Communications networks and in particular Ethernet networks, are becoming an increasingly popular means of exchanging data of various types and sizes for a variety of applications. In this regard, Ethernet networks are increasingly being utilized to carry voice, data, and multimedia traffic. Accordingly more and more devices are being equipped to interface to Ethernet networks. Broadband connectivity including internet, cable, phone and VOIP offered by service providers has led to increased traffic and more recently, migration to Ethernet networking. Much of the demand for Ethernet connectivity is driven by a shift to electronic lifestyles involving desktop computers, laptop computers, and various handheld devices such as smart phones and PDA's. Applications such as search engines, reservation systems and video on demand that may be offered at all hours of a day and seven days a week, have become increasingly popular.

These recent developments have led to increased demand on datacenters, aggregation, high performance computing (HPC) and core networking. As the number of devices connected to data networks increases and higher data rates are required, there is a growing need for new transmission technologies which enable higher data rates. Conventionally, however, increased data rates often results in significant increases in power consumption. In this regard, as an increasing number of portable and/or handheld devices are enabled for Ethernet communications, battery life may be a concern when communicating over Ethernet networks.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for packet preemption for low latency, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary Ethernet connection between two network devices, in accordance with an embodiment of the invention.

FIG. 2A is a block diagram illustrating an exemplary network device that is operable to utilize packet preemption for packets requiring low latency, in accordance with an embodiment of the invention.

FIG. 2B is a block diagram illustrating an exemplary egress queue that may comprise latency information utilized for packet preemption, in accordance with an embodiment of the invention.

FIG. 3A is a block diagram illustrating an exemplary first packet that may be transmitted by a network device and/or may be preempted, in accordance with an embodiment of the invention.

FIG. 3B is a block diagram illustrating an exemplary first packet preempted by a second packet, in accordance with an embodiment of the invention.

FIG. 3C is a block diagram illustrating exemplary packets that have been parsed, extracted and/or reconstructed from a plurality of preempted and/or nested packets and/or packet segments, in accordance with an embodiment of the invention.

FIG. 4 is a flow chart illustrating exemplary steps for preempting transmission of a first packet when a second packet comprising lower latency requirements than the first packet is available for delivery to a link partner, in accordance with an embodiment of the invention.

### DETAILED DESCRIPTION OF THE INVENTION

Certain embodiments of the invention can be found in a method and system for packet preemption for low latency. In various embodiments of the invention, an Ethernet network may comprise one or more link partners that may be coupled via an Ethernet link. The one or more link partners may comprise one or more PHY devices and one or more memory buffers. The one or more link partners may be operable to determine whether a link partner is configured to utilize packet preemption. In the Ethernet network, latency requirements may be determined for one or more of a plurality of packets that are pending transmission. Transmission may be interrupted for a first packet of the plurality of packets. In this regard, the first packet may comprise a latency that is greater than a latency of a second packet that is pending transmission. The second packet may be transmitted from a first link partner to a second link partner while transmission of the first packet is interrupted. An OSI layer 2 (L2) header, L2 payload or higher OSI layer information within the one or more of the plurality of packets pending transmission may be inspected to determine the latency requirements. Furthermore, one or more markings within the one or more of the plurality of packets that are pending delivery may be inspected to determine the latency requirements. Markings within a packet may be referred to as a tag, a mark and/or embedded bits. U.S. patent application Ser. No. 12/571,147, filed on Sep. 30, 2009 describes marked packets. The second packet may be transmitted after transmission of a first portion of the first packet and/or prior to transmission of a second portion of the first packet. One or more preemption delimiters may be inserted among data for the first packet and/or data for the second packet data for the interrupting of transmission of the first packet. Prior to completion of transmission of the first packet, it may be determined whether a packet that is pending delivery comprises a lower latency than the latency of the first packet.

The second link partner may receive the second packet prior to receiving one or more portions of the first packet. In this regard, one or more of a PHY layer, a MAC layer and/or a higher OSI layer of the second link partner may buffer the second packet and/or the portions of the first packet. Moreover, one or more of the PHY layer, the MAC layer and/or the higher OSI layers of the second link partner may parse the second packet and/or the portions of the first packet and/or may reconstruct data from the first packet and/or data from the second packet. In this regard, the portions of the first packet may be re-assembled. In various embodiments of the invention a third and/or more packets may preempt the second packet and/or the first packet.

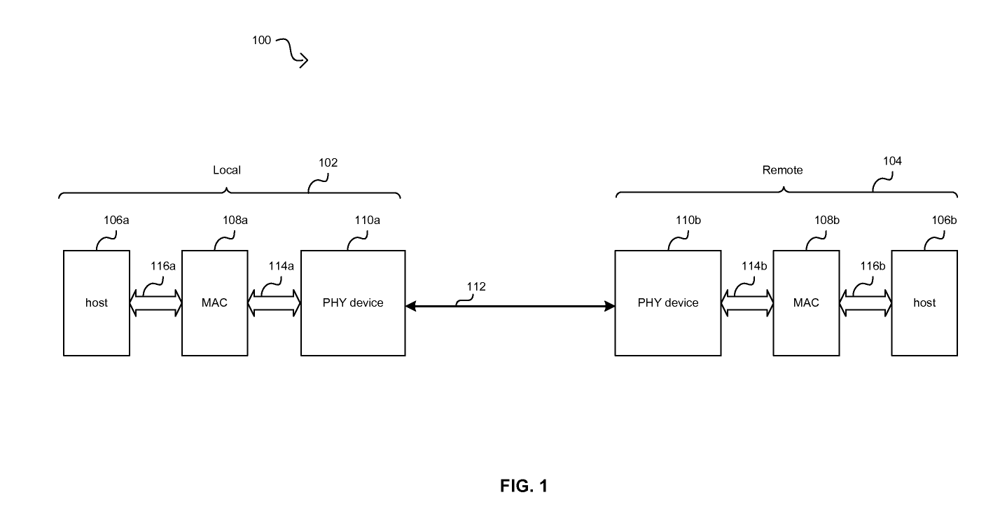

FIG. 1 is a block diagram illustrating an exemplary Ethernet connection between two network devices, in accordance with an embodiment of the invention. Referring to FIG. 1, there is shown a system 100 that comprises a network device 102 and a network device 104. In addition, there is shown two hosts 106a and 106b, two medium access (MAC) controllers 108a and 108b, a PHY device 110a and a PHY device 110b, interfaces 114a and 114b, bus controller interfaces 116a and 116b and a link 112

The network devices 102 and 104 may be link partners that may communicate via the link 112. The Ethernet link 112 is not limited to any specific medium and may utilize any suitable medium. Exemplary Ethernet link 112 media may comprise copper, optical and/or backplane technologies. For example, a copper medium such as STP, Cat 3, Cat 5, Cat 5e, Cat 6, Cat 7 and/or Cat 7a as well as ISO nomenclature variants may be utilized. Additionally, copper media technologies such as InfiniBand, Ribbon and backplane may be utilized. With regard to optical media for the Ethernet link 112, single mode fiber as well as multi-mode fiber may be utilized. In various embodiments of the invention, one or both of the network devices 102 and 104 may be operable to comply with one or more standards based on IEEE 802.3, for example, 802.3az.

In an exemplary embodiment of the invention, the link 112 may comprise up to four or more physical channels, each of which may, for example, comprise an unshielded twisted pair (UTP). The network device 102 and the network device 104 may communicate via two or more physical channels comprising the link 112. For example, Ethernet over twisted pair standards 10BASE-T and 100BASE-TX may utilize two pairs of UTP while Ethernet over twisted pair standards 1000BASE-T and 10GBASE-T may utilize four pairs of UTP. In this regard, however, aspects of the invention may enable varying the number of physical channels via which data is communicated.

The network device 102 may comprise a host 106a, a medium access control (MAC) controller 108a and a PHY device 110a. The network device 104 may comprise a host 106b, a MAC controller 108b, and a PHY device 110b. The PHY device(s) 110a and/or 110b may be pluggable transceiver modules or may be an integrated PHY device. Notwithstanding, the invention is not limited in this regard. In various embodiments of the invention, the network device 102 and/or 104 may comprise, for example, a network switch, a router, computer systems or audio/video (NV) enabled equipment. In this regard, NV equipment may, for example, comprise a microphone, an instrument, a sound board, a sound card, a video camera, a media player, a graphics card, or other audio and/or video device. The network devices 102 and 104 may be enabled to utilize Audio/Video Bridging and/or Audio/video bridging extensions (collectively referred to herein as audio video bridging or AVB) for the exchange of multimedia content and associated control and/or auxiliary data.

In various embodiments of the invention, one or both of the network devices 102 and 104 may be configured as an endpoint device and/or one or both of the network devices 102 and 104 may be configured as an internal network core device, for example, a switch. Moreover, one or both of the network devices 102 and 104 may be operable to determine latency requirements of packet data that may be pending delivery. In this regard, latency requirements may be related to a rate at which packets may need to be delivered to a destination in order to provide an acceptable quality of communication and/or user experience. Exemplary packets may comprise interactive online gaming packets, premium service class packets, voice and/or video communications.

A network device may be operable to insert into a packet, a mark that may comprise information that may indicate latency requirements of the packet. For example, latency requirements may be based on the type of data that may be within the packet or a class of service associated with the packet. In this regard, one or both of the network devices 102 and 104 may be configured as a network node along a communication path that the marked packet may follow. One or both of the network devices 102 and 104 may be operable to inspect the inserted latency information and may determine whether delivery of the marked packet should preempt delivery of a first packet that may have already begun to be transmitted to a link partner but may not yet have completed transmission. In this regard, the transmitting link partner may stop or interrupt transmission of the first packet before transmission is complete and may begin transmission of the second packet In other exemplary embodiments of the invention, one or both of the network devices 102 and 104 may be configured to perform packet inspection, wherein packet headers and/or packet payload may be inspected to determine which type of data and/or latency requirements that the packet may comprise.

The PHY device 110a and the PHY device 110b may each comprise suitable logic, circuitry, interfaces and/or code that may enable communication, for example, transmission and reception of data, between the network device 102 and the network device 104. The PHY device(s) 110a and/or 110b may comprise suitable logic, circuitry, interfaces and/or code that may provide an interface between the network device(s) 102 and/or 104 to an optical and/or copper cable link 112.

The PHY device 110a and/or the PHY device 110b may be operable to support, for example, Ethernet over copper, Ethernet over fiber, and/or backplane Ethernet operations. The PHY device 110a and/or the PHY device 110b may enable multi-rate communications, such as 10 Mbps, 100 Mbps, 1000 Mbps (or 1 Gbps), 2.5 Gbps, 4 Gbps, 10 Gbps, 40 Gbps or 100 Gbps for example. In this regard, the PHY device 110a and/or the PHY device 110b may support standard-based data rate limits and/or non-standard data rate limits. Moreover, the PHY device 110a and/or the PHY device 110b may support standard Ethernet link lengths or ranges of operation and/or extended ranges of operation. The PHY device 110a and/or the PHY device 110b may enable communication between the network device 102 and the network device 104 by utilizing a link discovery signaling (LDS) operation that enables detection of active operations in the other network device. In this regard the LDS operation may be configured to support a standard Ethernet operation and/or an extended range Ethernet operation. The PHY device 110a and/or the PHY device 110b may also support autonegotiation for identifying and selecting communication parameters such as speed and duplex mode.

The PHY device 110a and/or the PHY device 110b may comprise a twisted pair PHY capable of operating at one or more standard rates such as 10 Mbps, 100 Mbps, 1 Gbps, and 10 Gbps (10BASE-T, 100GBASE-TX, 1GBASE-T, and/or 10GBASE-T); potentially standardized rates such as 40 Gbps and 100 Gbps; and/or non-standard rates such as 2.5 Gbps and 5 Gbps. The PHY device 110a and/or the PHY device 110b may comprise a backplane PHY capable of operating at one or more standard rates such as 10 Gbps (10GBASE-KX4 and/or 10GBASE-KR); and/or non-standard rates such as 2.5 Gbps and 5 Gbps. The PHY device 110a and/or the PHY device 110b may comprise a optical PHY capable of operating at one or more standard rates such as 10 Mbps, 100 Mbps, 1 Gbps, and 10 Gbps; potentially standardized rates such as 40 Gbps and 100 Gbps; and/or non-standardized rates such as 2.5 Gbps and 5 Gbps. In this regard, the optical PHY may be a passive optical network (PON) PHY.

The PHY device 110a and/or the PHY device 110b may support multi-lane topologies such as 40 Gbps CR4, ER4, KR4; 100 Gbps CR10, SR10 and/or 10 Gbps LX4 and CX4. Also, serial electrical and copper single channel technologies such as KX, KR, SR, LR, LRM, SX, LX, CX, BX10, LX10 may be supported. Non standard speeds and non-standard technologies, for example, single channel, two channel or four channels may also be supported. More over, TDM technologies such as PON at various speeds may be supported by the network devices 102 and/or 104.

In various embodiments of the invention, the PHY device 110a and/or the PHY device 110b may comprise suitable logic, circuitry, and/or code that may enable transmission and/or reception at a high(er) data in one direction and transmission and/or reception at a low(er) data rate in the other direction. For example, the network device 102 may comprise a multimedia server and the network device 104 may comprise a multimedia client. In this regard, the network device 102 may transmit multimedia data, for example, to the network device 104 at high(er) data rates while the network device 104 may transmit control or auxiliary data associated with the multimedia content at low(er) data rates.

The data transmitted and/or received by the PHY device 110a and/or the PHY device 110b may be formatted in accordance with the well-known OSI protocol standard. The OSI model partitions operability and functionality into seven distinct and hierarchical layers. Generally, each layer in the OSI model is structured so that it may provide a service to the immediately higher interfacing layer. For example, layer 1, or physical layer, may provide services to layer 2 and layer 2 may provide services to layer 3. The hosts 106a and 106b may implement layer 3 and above, the MAC controllers 108a and 108b may implement layer 2 and above and the PHY device 110a and/or the PHY device 110b may implement the operability and/or functionality of layer 1 or the physical layer. In this regard, the PHY device 110a and/or the PHY device 110b may be referred to as physical layer transmitters and/or receivers, physical layer transceivers, PHY transceivers, PHYceivers, or PHY, for example. The hosts 106a and 106b may comprise suitable logic, circuitry, and/or code that may enable operability and/or functionality of the five highest functional layers for data packets that are to be transmitted over the link 112. Since each layer in the OSI model provides a service to the immediately higher interfacing layer, the MAC controllers 108a and 108b may provide the necessary services to the hosts 106a and 106b to ensure that packets are suitably formatted and communicated to the PHY device 110a and/or the PHY device 110b. During transmission, a device implementing a layer function may add its own header to the data passed on from the interfacing layer above it. However, during reception, a compatible device having a similar OSI stack may strip off the headers as the message passes from the lower layers up to the higher layers.

The PHY device 110a and/or the PHY device 110b may be configured to handle physical layer requirements, which include, but are not limited to, packetization, data transfer and serialization/deserialization (SERDES), in instances where such an operation is required. Data packets received by the PHY device 110a and/or the PHY device 110b from MAC controllers 108a and 108b, respectively, may include data and header information for each of the six functional layers above the PHY layer. The PHY device 110a and/or the PHY device 110b may be configured to encode data packets that are to be transmitted over the link 112 and/or to decode data packets received from the link 112.

In various embodiments of the invention, one or both of the PHY device 110a and the PHY device 110b, may comprise suitable logic, circuitry, interfaces, and/or code that may be operable to implement one or more energy efficient Ethernet (EEE) techniques in accordance with IEEE 802.3az as well as other energy efficient network techniques. For example, the PHY device 110a and/or the PHY device 110b may be operable to support low power idle (LPI) and/or sub-rating, also referred to as subset PHY, techniques. LPI may generally refer a family of techniques where, instead of transmitting conventional IDLE symbols during periods of inactivity, the PHY device 110a and/or the PHY device 110b may remain silent and/or communicate signals other than conventional IDLE symbols. Sub-rating, or sub-set PHY, may generally refer to a family of techniques where the PHYs are reconfigurable, in real-time or near real-time, to communicate at different data rates. In a sub-rate PHY mode, a network device may communicate at less than a negotiated maximum data rate. In a sub-set PHY mode, PHY circuitry that handles a portion of channels on a link may be silent and/or operating in a lower power mode.

In various embodiments of the invention, the hosts 106a and/or 106b may be operable to communicate control information with the PHY devices 110a and/or 110b via an alternate path. For example, the host 106a and/or the host 106b may be operable to communicate via a general purpose input output (GPIO) and/or a peripheral component interconnect express (PCI-E).

The MAC controller 108a may comprise suitable logic, circuitry, and/or code that may enable handling of data link layer, layer 2, operability and/or functionality in the network device 102. Similarly, the MAC controller 108b may comprise suitable logic, circuitry, and/or code that may enable handling of layer 2 operability and/or functionality in the network device 104. The MAC controllers 108a and 108b may be configured to implement Ethernet protocols, such as those based on the IEEE 802.3 standards, for example. Notwithstanding, the invention is not limited in this regard.

The MAC controller 108a may communicate with the PHY device 110a via an interface 114a and with the host 106a via a bus controller interface 116a. The MAC controller 108b may communicate with the PHY device 110b via an interface 114b and with the host 106b via a bus controller interface 116b. The interfaces 114a and 114b correspond to Ethernet interfaces that comprise protocol and/or link management control signals. For example, the interface 114 may comprise a control interface such as a management data input/output (MDIO) interface. Furthermore, the interfaces 114a and 114b may comprise multi-rate capable interfaces and/or media independent interfaces (MII). For example, the interfaces 114a and/or 114b may comprise a media independent interface such as a XGMII, a GMII, or a RGMII for communicating data to and/or from the PHY device 110a. In this regard, the interface 114 may comprise a signal to indicate that data from the MAC controller 108a to the PHY device 110a is imminent on the interface 114a. Such a signal is referred to herein as a transmit enable (TX_EN) signal. Similarly, the interface 114a may utilize a signal to indicate that data from the PHY 110a to the MAC controller 108a is imminent on the interface 114a. Such a signal is referred to herein as a receive data valid (RX_DV) signal. The interfaces 114a and/or 114b may be configured to utilize a plurality of serial data lanes for sending and/or receiving data. The bus controller interfaces 116a and 116b may correspond to PCI or PCI-X interfaces. Notwithstanding, the invention is not limited in this regard.

In operation, one or both network devices 102 and 104 may be operable to determine latency requirements for one or more packets that are pending delivery and may be operable to preempt transmission of a packet in instances when one or more subsequent packets comprise more stringent constraints with regard to latency. In this regard, one or both of the network devices 102 and 104 may be operable to parse and/or inspect packets for latency information. The packets may be marked with latency information, for example, in a L2 header, in a portion of the payload and/or in a preamble, for example. The marking of packets may be performed by an endpoint device, by a network core device or by any device along a communication path where the packet may be processed.

Packet preemption capabilities may be part of a standardized or non-standard protocol. Network devices may be operable to determine whether another device is operable to perform packet preemption. For example, packet preemption capabilities may be communicated during auto negotiation or as a L2 capability during link layer discovery. In instances when a network device determines that another network device does not comprise packet preemption capabilities, the first network device may remove packet preemption or latency markings from a packet prior to sending it to the other network device.

In an exemplary embodiment of the invention, the MAC 108a and/or PHY 110a may be in the process of transmitting a packet to the network device 104. The host device 106a may comprise a switch, for example, and may be operable to compare latency requirements of the packet in transmission with latency requirements of one or more packets that may be pending delivery by the network device 102 to the network device 104. The host device 106a may determine that a second, and/or more packets have greater sensitivity to latency than the packet being transmitted. The host device 106a may communicate the second and/or additional packets to the MAC controller 108a. The MAC controller 108a may interrupt transmission of the first packet and may begin transmitting the second and/or more packets. In this manner, packets may be nested within one another for packet preemption.

Upon completion of transmission of the second and/or more packets, the MAC 108a may finish communicating the first packet to the network device 104. The network device 102 may insert delimiters within or between different packets and/or portions of packets to communicate how or where packet preemption occurs to the network device 104. In an exemplary embodiment of the invention, the network device 104 may receive a first segment of a first packet, followed by the second packet which may be followed by the second segment of the first packet. As a receiving link partner, the network device 104 may extract and/or store the received packets and/or packet segments. The network device 104 may reconstruct the first packet from the two segments of the packet that were separated by the second packet during transmission. In instances when the transmitting link partner may have a third packet or more packets that may be pending delivery that may have a higher sensitivity to latency than the first and/or second packets, the MAC 108a may preempt a packet currently undergoing transmission and may begin transmitting the third packet, for example. In this regard, the receiving link partner, for example, network device 104, may extract the received packets and/or packet segments and may reconstruct the first, second and/or third packets.

In an exemplary embodiment of the invention, the network device 102 may be in the process of transmitting, for example, a packet comprising data that may be associated with web browsing and/or may be tolerant of latency. The network device 102 may receive a VOIP packet and/or may determine that the VOIP packet requires lower latency for high quality and successful communication relative to the web browsing data. In this regard, the associated latency for the VoIP packet is less than the associated latency for the web browsing packet. The network device 102 may stop the process of transmitting the web related packet and may hold and/or store a portion of the packet that has not yet been transmitted. The network device 102 may begin transmission of the VOIP packet. When the VOIP packet transmission has ended, the network device 102 may transmit the remaining portion of the web related packet.

The network device 104 may receive the first portion of the web related packet followed by the VOIP packet followed by the second portion of the web related packet. The network device 104 may extract the VOIP packet and/or the portions of the web related packet and may reconstruct the VOIP and web related packets. In this regard, one or more of the PHY 110b, the MAC controller 108b and/or the host 106b in the network device 104 may comprise suitable logic, circuitry, interfaces and/or code that may be operable to extract packet segments and/or reassemble or otherwise reconstruct packet segments.

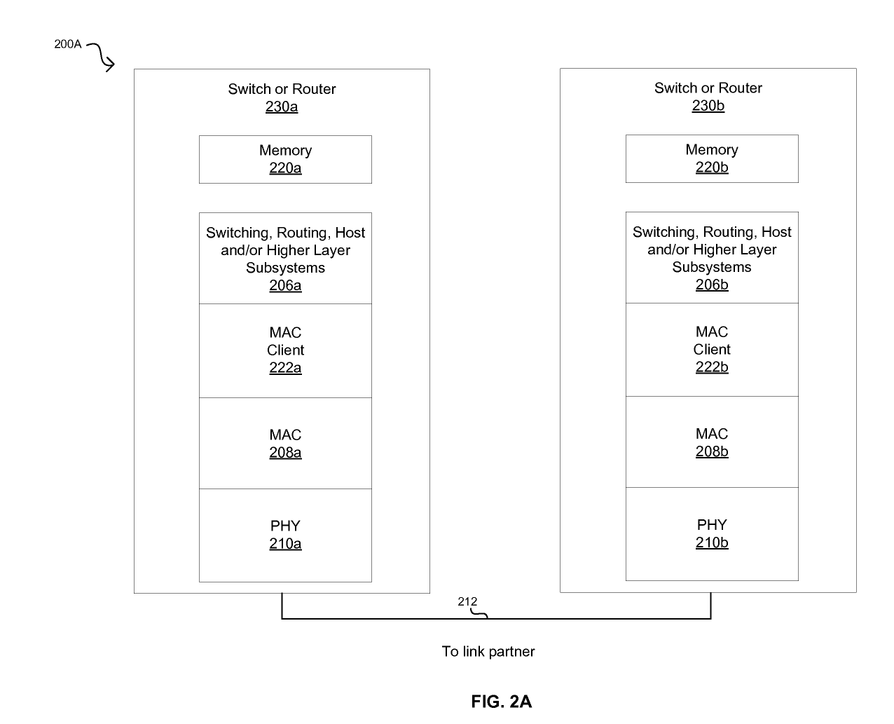

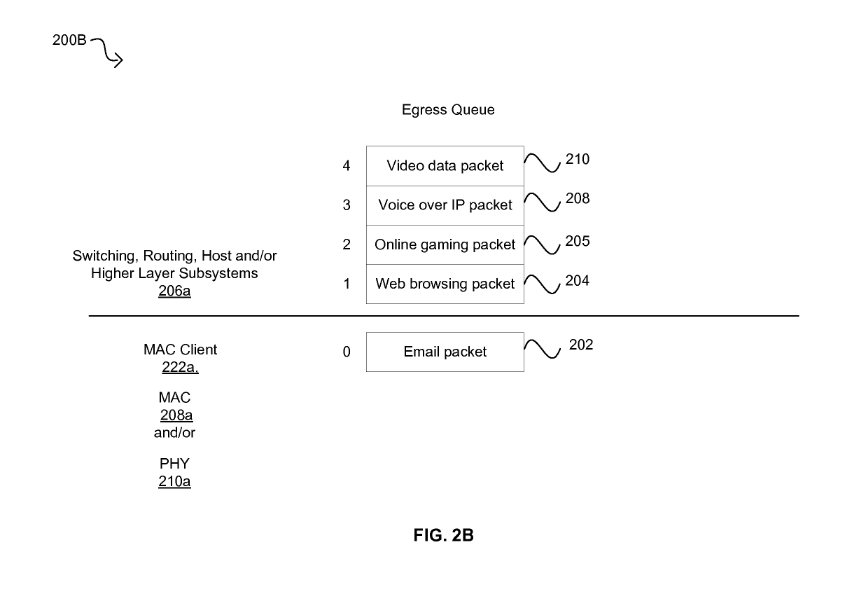

FIG. 2A is a block diagram illustrating exemplary network devices that are operable to utilize packet preemption for packets requiring low latency, in accordance with an embodiment of the invention. Referring to FIG. 2A, there is shown a system 200B comprising network device 230a and 230b and a communication link 212. The network device 230a may comprise switching, routing, host and/or higher layer subsystems 206a, a MAC client 222a, a MAC controller 208a, a PHY device 210a and a memory 220a. The network device 230b may comprise switching, routing, host and/or higher layer subsystems 206b, a MAC client 222b, a MAC controller 208b, a PHY device 210b and a memory 220b.

The network device 230a and/or 230b may be similar or substantially the same as the network devices 102 and/or 104 described with respect to FIG. 1. The communication link 212 may be similar and/or substantially the same as the link 112. The switching, routing, host and/or higher layer subsystems 206a and 206b, the MAC controllers 208a and 208b and the PHY devices 210a and 210b may be similar and/or substantially the same as the hosts 106a and/or 106b, the MAC controllers 108a and 108b and/or the PHY devices 110a and/or 110b respectively.

The MAC client blocks 204a and/or 204b may comprise suitable logic, circuitry, interfaces and/or code that may operable to receive packet data from the switching, routing, host and/or higher layer subsystems 206a and/or 206b and/or to encapsulate the packet data as Ethernet payloads into one or more Ethernet frames. The Ethernet frames may be communicated from the MAC client block 222a to the MAC controller 208a. In this regard, the MAC client 222a may be operable to handle generating header information for packets that may be preempted so that packets comprising more stringent latency requirements may be communicated to a link partner before packets with a greater tolerance for latency. For example, the MAC client block 222a may process a first packet for transmission to a link partner, for example, the network device 230b. The MAC client 222a may receive a second packet that may require lower latency than the first packet. The MAC client 222a may stop processing the first packet and may generate a packet header for the second packet that may comprise data that may indicate the second packet is being transmitted prior to the end of the first packet. Once the second packet has been communicated, the MAC client 222 may generate a packet header to indicate that the second packet has ended and that the remaining portion of the second packet is being transmitted to the link partner.

The memory 220a and/or 220b may comprise suitable logic, circuitry, interfaces and/or code that may be operable to store packet data and/or packet information, for example, packet header information. In this regard, when the network device 230a may be transmitting packets, the memory 220a may comprise an egress queue for the network device 230a that may hold packet data during a preemption process. In instances when transmission of a packet may be interrupted prior to completion of transmission of the entire packet, a portion of the packet that has not been transmitted yet may be stored in the memory 220a until a time instant when transmission of the packet may resume. In instances when a link partner, for example, the network device 230b, may be receiving one or more packets that have been preempted by a second packet, the memory 220b may be utilized to store packets and/or portions of packets until the packets may be reconstructed. The memories 220a and/or 220b may comprise an index and/or link list, for example, of packet headers, which may comprise pointers that correspond to packet data and/or packet information stored in the memories 220a and/or 220b. Moreover, the memories 220a and/or 220b may comprise content addressable memory (CAM) that may enable modification of stored information base on a type of content within the memory. For example, control data and/or packet header information that may correspond to a stored packet and/or a portion of a packet may be stored in CAM.

In operation, the network devices 230a and/or 230b may be operable to transmit and/or receive packets utilizing packet preemption. Furthermore, the network device 230a and/or 230b may be operable to receive packets and/or portions of packets that may be received in segments wherein the segments may be separated by other packets and/or segments of other packets and may reconstruct packets from the segments. In this regard, utilization of packet preemption may be determined based on latency requirements of packet data that may be pending delivery. In instances when the network device 230a is transmitting a first packet and determines that a second packet may have a lower tolerance for latency than the first packet, the network device 230a may interrupt transmission of the first packet prior to completion of transmission of the entire first packet and/or may store a portion or segment of the packet that has not yet been transmitted. In this regard, the packet segment and/or information about the packet segment may be stored in an egress buffer in memory 220a. The network device 230a may transmit the second packet prior to resuming transmission of the remaining portion and/or segment of the first packet.

The switching, routing, host and/or higher layer subsystems 206a and/or 206b may determine latency requirements and/or service class based on inspection of one or more packets. For example, markings that may indicate latency requirements and/or service class may be inserted in the packet and may be read by the switching, routing, host and/or higher layer subsystems 206a and/or 206b. For example, latency requirements may depend on an application that generates the packet and/or on a capability of a device that generated and/or may render the packet. Alternatively, OSI layer 2 packet headers, payload and/or a preamble may be inspected to provide an indication of latency requirements, for example, based on a type of data within the packet. Based on the determined latency requirements, the switching, routing, host and/or higher layer subsystems 206a and/or 206b may determine that packet preemption should be utilized. The MAC clients 222a and/or 222b may generate packet preemption delimiters that may indicate when a packet is preempted and/or that may provide information that may enable a receiving network device to reassemble or otherwise reconstruct the segmented packets.

In instances when the network device 230b may be receiving preempted packets and/or packet segments with embedded lower latency packets, the reconstruction of the packet segments may be performed at one or more of the PHY device 210b, the MAC controller 208b, the MAC client 222b and/or the switching, routing, host and/or higher layer subsystems 206b. In this manner, a packet requiring the lowest latency may be transmitted and received as soon as possible. A network device 230a may be in the process of transmitting a first packet to a link partner and a second packet requiring a lower latency may be ready for transmission. The network device 230a may not wait for the transmission of the first packet to end before communicating the packet requiring a lower latency.

FIG. 2B is a block diagram illustrating an exemplary egress queue that may comprise latency information utilized for packet preemption, in accordance with an embodiment of the invention. Referring to FIG. 2B, there is shown an egress queue 200B, the switching, routing, host and/or higher layer subsystems 206a, the MAC client 220a, the MAC 208a, the PHY 210a and an egress queue comprising a plurality of storage locations 202, 204, 205, 208 and/or 210.

The egress queue 200B comprising the storage locations 202, 204, 205, 208 and/or 210 may comprise a portion of the memory 220a in the switch and/or router 230a described with respect to FIG. 2A. In operation, the network device 230a may be operable to store and/or index packets and/or packet information in the egress queue 200B. The MAC client 220a may be in the process of transmitting a first packet stored in the memory location 202 to a link partner, for example, the network device 230b. The network device 230a may determine that another packet stored in the egress queue may have higher priority for transmission than the first packet that is currently being transmitted from memory location 202. For example, the switching, routing, host and/or higher layer subsystems 206a may comprise suitable logic, circuitry, interfaces and/or code that may be operable to inspect markers comprising latency requirements, for example, in one or more packets stored in the storage locations 202, 204, 205, 208 and/or 210 for example.

The switching, routing, host and/or higher layer subsystems 206a may be operable to determine that a second packet, for example, a packet stored in the storage location 205 may require less latency than the first packet that is currently being transmitted and may interrupt transmission of the first packet after only a first portion of the first packet is transmitted. In this regard, a packet delimiter may be inserted between the first portion of the first packet and the second packet from the storage location 205. The network device 230a may transmit the second packet and may insert another preemption delimiter after transmission of the second packet. The network device 230a may resume transmitting the first packet. In various embodiments of the invention, a third packet may preempt the second packet, for example, in instances when the switching, routing, host and/or higher layer subsystems 206a determines that the third packet has priority over the second packet.

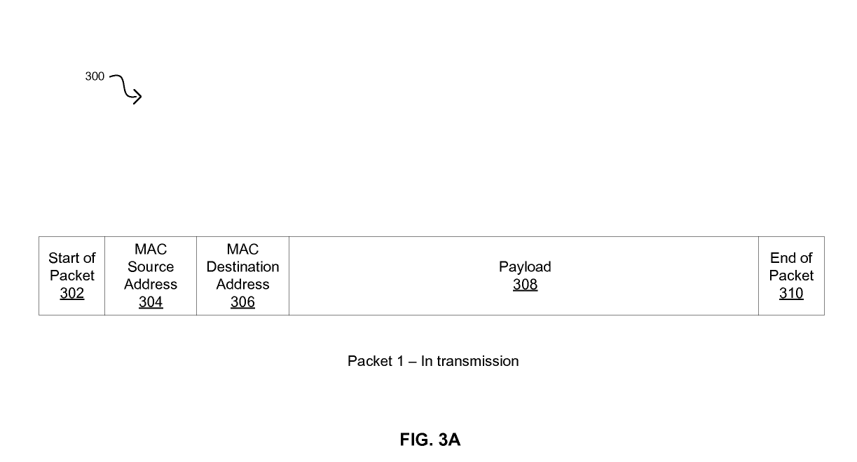

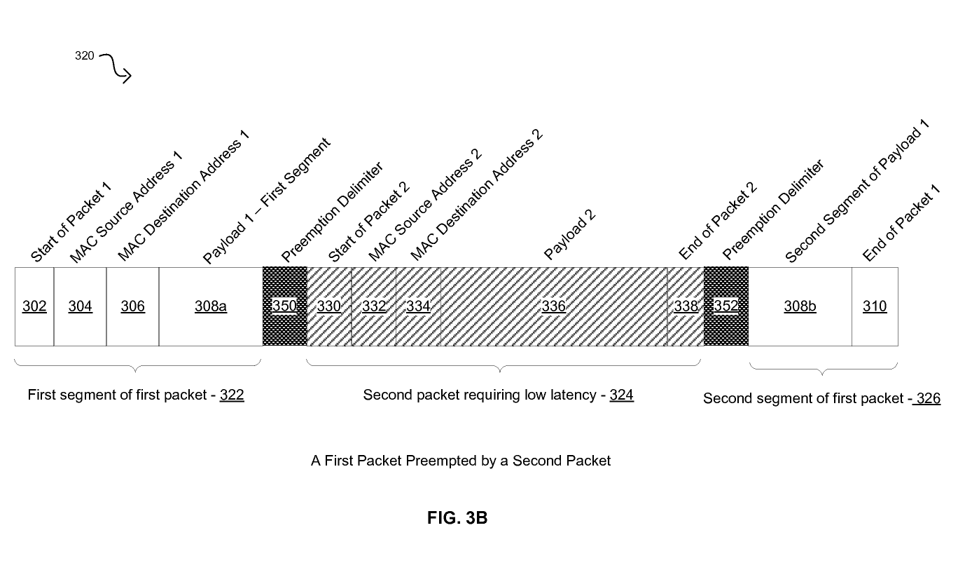

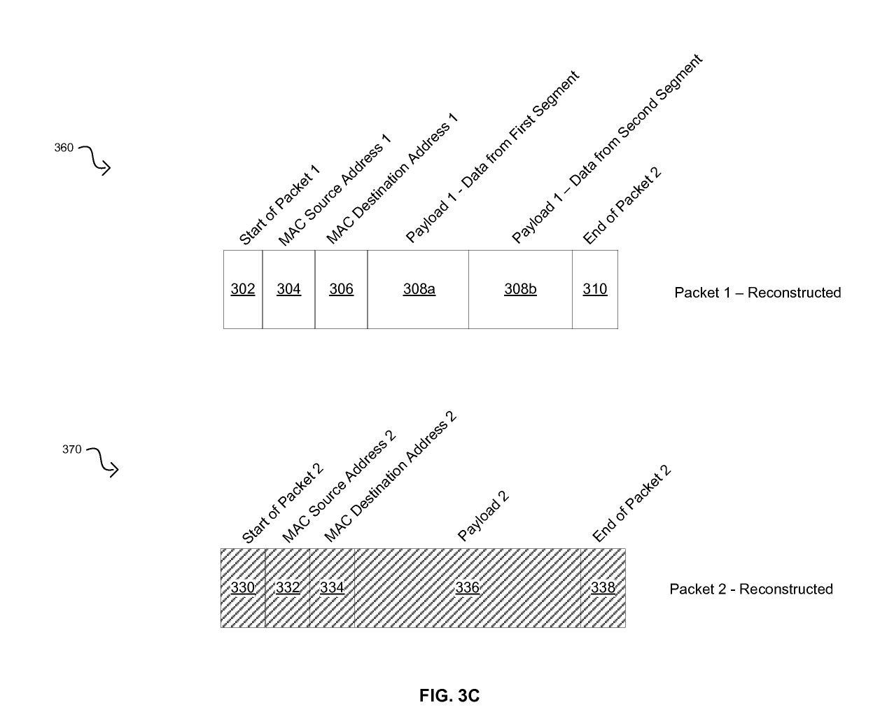

FIG. 3A is a block diagram illustrating an exemplary first packet that may be transmitted by a network device and/or may be preempted, in accordance with an embodiment of the invention. Referring to FIG. 3A, there is shown a packet 300 that may comprise a start of a packet header 302, a MAC source address header (MAC SAH) 304, a MAC destination address header (MAC DAH) 306, a payload 308, and an end of packet header 310.

The start of packet header 302 may indicate to a receiving network device, for example the network device 230b, where the packet 300 begins. The MAC SAH 304 may indicate which network device is transmitting the packet 300 and the MAC DAH 306 may indicate which device is receiving the packet 300. The payload 308 may comprise packet data and/or headers for higher layer processing. The payload 308 may be associated with a level of latency that may be desired for an acceptable quality of communication. In this regard, the packet 300 may be marked with a latency specification. For example, the payload 308 may comprise data utilized in web browsing that may be somewhat tolerant to latency. The end of packet 310 may indicate to a receiving device 230b where the packet 300 ends.

In operation, the network device 230a may begin transmitting the packet 300 to the network device 230b via the PHY 210b. The network device 230a may receive a second packet for transmission via the PHY device 210b. The network device 210b may inspect the second packet to determine a specified latency for delivery of the second packet. In instances when information within the second packet indicates that the second packet has less time to reach its destination than the first packet 300, transmission of the first packet 300 may be interrupted and the remaining portion and/or segment of the first packet 300 may be stored within the memory 222a. The MAC client 222a may generate a header for the end of the first portion and/or first segment of the first packet 300 and/or may generate a header to indicate that the first packet 300 has been preempted and transmission of a second packet has begun.

The MAC client 222a may be operable to generate a header for the end of the second packet and/or the beginning of the second portion and/or second segment of the first packet 300. The network device 230a may transmit the second packet prior to communicating the remaining portion and/or segment of the first packet 300.

In a similar manner, when the second packet that has preempted the first packet 300 is being transmitted and a third packet with a more stringent latency requirement or a higher priority than the first packet 300 and the second packet becomes available for delivery, the second packet may be preempted. In this regard, transmission of the second packet may be interrupted and the third packet may be transmitted. After the third packet is transmitted, the second packet may continue transmission. After the second packet is transmitted the first packet may continue transmission. In this manner any suitable number of packet preemptions may be nested and/or chained in a sequence prior to completing transmission of the first packet.

FIG. 3B is a block diagram illustrating an exemplary first packet preempted by a second packet, in accordance with an embodiment of the invention. Referring to FIG. 3B, there is shown a plurality of packets 320 that may comprise a first segment of a first packet 322, a second packet 324 and a second segment of the first packet 326. The first segment of the first packet 322 may comprise the start of packet header 302, the MAC source address header (MAC SAH) 304, the MAC destination address header (MAC DAH) 306 and a first portion of the payload 308 indicated by 308a. In addition, the second packet 324 may comprise a start of packet header 330, a MAC SAH 332, a MAC DAH 334, a payload 336 and an end of packet header 338. The second segment of the first packet 326 may comprise a second portion of the payload 308 indicated by 308b and an end of packet header 310. There is also shown a preemption delimiter 350 and a preemption delimiter 352.

The plurality of packets 320 may illustrate an order for transmitting packets and/or portions of and/or segments of packets utilizing preemption for low latency packets described with respect to FIG. 1 and/or FIG. 2. The first segment of the first packet 322 and the second segment of the first packet 326 may comprise the packet 300 as described with respect to FIG. 3A.

The second packet 324 may comprise the start of packet header 330, a MAC SAH 332, a MAC DAH 334 and an end of packet header 338 that may be similar to the start of packet header 302, the MAC SAH 304, the MAC DAH 306 and the end of packet header 310 respectively, described with respect to FIG. 3A. The payload 336 may be associated with a specified level of latency that may be desired for communicating the second packet 324 with an acceptable quality or performance. In this regard, the second packet 324 may be marked with a latency specification for data that may be utilized for low latency applications such as voice over IP (VOIP) or online gaming. Therefore, the second packet 324 may require an end to end low latency for good quality voice communication. The second packet 324 may be nested between the segments 322 and 326 of the first packet 300. In various embodiments of the invention, similar mechanisms may be utilized to nest a third higher priority packet within the second packet 324, for example.

The preemption delimiters 350 and/or 352 may indicate where one packet is preempted by another packet and/or where preemption may be complete and transmission of a remaining portion of the preempted packet may resume. Any suitable technique may be utilized to generate the preemption delimiters 350 and/or 352. For example, reserved code groups, special characters, a modified idle pattern, reserved bits in an LDPC frame and/or control characters may be utilized. In various embodiments of the invention, a mini packet segment may be communicated to indicate which packet is preempted, The preemption delimiters may be inserted in a packet preamble, a packet header and/or near the beginning of a layer 2 payload, for example. The preemption delimiters 350 and/or 352 may comprise information that may enable a network device, for example, the network device 230b, to receive the plurality of packets 320, to extract data from one or more different packets and to reconstruct the packets prior to further processing and/or communication to another device. In this regard, the preemption delimiter 350 may comprise information that may identify the first packet 300 and/or information that may indicate that a break has occurred in the transmission of the first packet 300. The preemption delimiter 352 may comprise information that may identify the first packet 300 and/or may indicate that a second portion or segment of the first packet 326 is beginning. In various embodiments of the invention, the preemption delimiter 352 may indicate whether the second segment of the first packet 323 is the final segment of the first packet.

In operation, a network device, for example, the network device 230a, may begin transmitting the first packet 300, however, the network device 230a may determine that the second packet 324 may be sent prior to completion of transmission of the packet 300. In this regard, the network device 230a may transmit the first segment of the first packet 322 followed by the second packet 324, followed by the second segment of the first packet 326. In addition, the network device 230a may insert the preemption delimiter 350 prior to sending the second packet 324 and/or the preemption delimiter 352 prior to sending the second portion of the first packet 324. The plurality of packets 320 may be received by a link partner, for example, the network device 230b that may be operable to parse and/or extract packet data from the plurality of packets 320 and may be operable to reconstruct data from the first packet 300 and/or the second packet 324. Although the delimiter 350 is shown within the payload 308a, the invention is not so limited. In this regard, preemption may occur during transmission of a header for example, and a delimiter may be inserted within the header.

FIG. 3C is a block diagram illustrating exemplary packets that have been parsed, extracted and/or reconstructed from a plurality of preempted and/or nested packets and/or packet segments, in accordance with an embodiment of the invention. Referring to FIG. 3C, there is shown a first reconstructed packet 360 and a second reconstructed packet 370. The first reconstructed packet 360 may comprise the start of a packet header 302, the MAC source address header (MAC SAH) 304, the MAC destination address header (MAC DAH) 306, the payload data 308a and 308b, and the end of packet header 310. The second reconstructed packet 370 may comprise the start of packet header 330, the MAC SAH 332, the MAC DAH 334, the payload 336 and the end of packet header 338.

The first reconstructed packet 360 may comprise packet data that may be extracted from the plurality of packets 320 by a receiving network device, for example, the network device 230b. In this regard, the receiving network device 230b may extract the first segment of the first packet 322 and the second segment of the first packet 326 and may assemble the data into a single packet. Accordingly, the reconstructed packet 360 may comprise the same data and/or same payload data as the first packet 300 described with respect to FIG. 3A.

The second reconstructed packet 370 may also comprise packet data that may be parsed and/or extracted from the plurality of packets 320 by the receiving network device 230b. In this regard, the reconstructed packet 370 may comprise the same data and/or same payload data as the second packet 324 described with respect to FIG. 3B.

In operation, a network device, for example, the network device 230b may receive the plurality of packets 320. The network device 230b may utilize the preemption delimiters 350 and/or 352 described with respect to FIG. 3B to parse the plurality of packets 320 and/or to extract and/or reconstruct the first segment of the first packet 322, the second packet 324 and/or the second segment of the first packet 326. The receiving network device 230b may construct the first packet 360 and the second packet 370 from the parsed and/or extracted packet data.

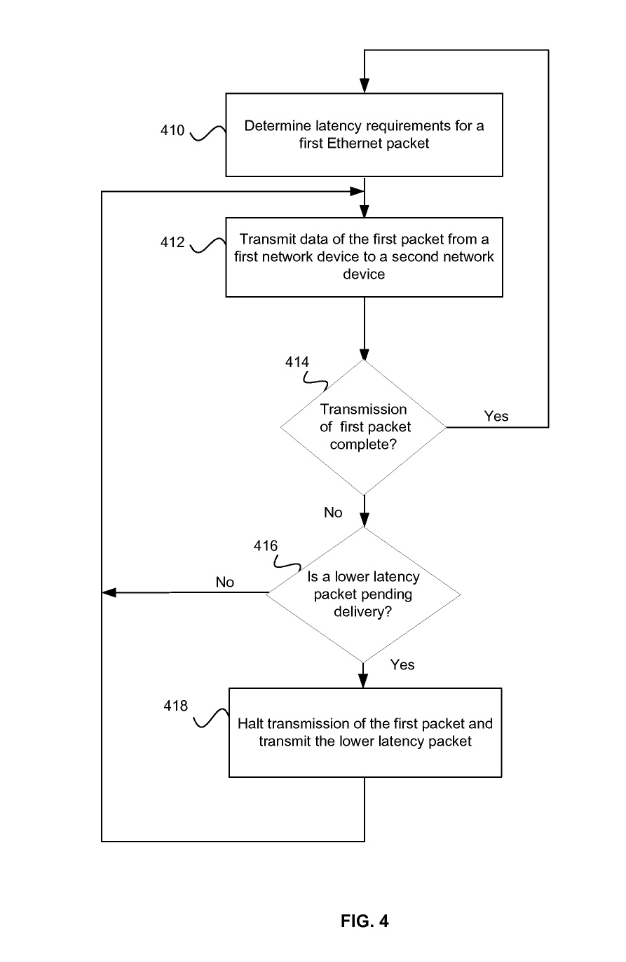

FIG. 4 is a flow chart illustrating exemplary steps for preempting transmission of a first packet when a second packet comprising lower latency requirements than the first packet is available for delivery to a link partner, in accordance with an embodiment of the invention. Referring to FIG. 4, the exemplary steps may begin with step 410. In step 410, latency requirements may be determined for a first packet that may be awaiting transmission via a specified port of the network device 230a, for example, via the PHY 210. In step 412, the network device 230a may transmit data of the first packet to a second network device, for example, the network device 230b. In step 414, in instances when the network device 230a has not completed the process of transmitting the first packet, the exemplary steps may proceed to step 416. In step 416, in instances when a lower latency packet is available for delivery via the PHY 210, the exemplary steps may proceed to step 418. In step 418, transmission of the first packet may be suspended or interrupted and the network device 230a may transmit the lower latency packet. The exemplary steps may proceed to step 412. In step 414, in instances when the network device 230a may have completed transmission of the first packet, the exemplary steps may proceed to step 410. In step 416, in instances when there is no packet available with lower latency requirements than the first packet, the exemplary steps may proceed to step 412.

In an embodiment of the invention, an Ethernet network, for example, the system 100, may comprise one or more link partners, for example, the network devices 102, 104 and/or 230a and/or 230b that may be coupled via an Ethernet link, for example, the link 112 or the link 212. The one or more link partners may comprise one or more PHY devices, for example, PHY devices 110a, 110b and/or 210a and/or 210b and one or more memory buffers, for example, memory 220a and/or 220b. The one or more link partners may be operable to determine whether a link partner is configured to utilize packet preemption. In the Ethernet network latency requirements may be determined for one or more of a plurality of packets that are pending transmission, for example, the packets 300 and/or 324. Transmission may be interrupted for a first packet 300 of the plurality of packets. In this regard, the first packet 300 may comprise a latency that is greater then a latency of a second packet 324 that is pending transmission. The second packet 324 may be transmitted from a first link partner 230a for example, to a second link partner 230b, for example, while transmission of the first packet 300 is interrupted. OSI layer 2 or higher OSI layer information within the one or more of the plurality of packets 300 and/or 324 pending transmission may be inspected to determine the latency requirements. Furthermore, one or more marks within the one or more of the plurality of packets 300 and/or 324 that are pending delivery may be inspected to determine the latency requirements. Accordingly, the second packet 324 may be transmitted after transmission of a first portion of the first packet 322 and/or prior to transmission of a second portion of the first packet 326. One or more delimiters 350 and/or 352 may be inserted among data for the first packet 300 and/or data for the second packet 324 for the interrupting of transmission of the first packet 300. Prior to completion of transmission of the first packet 300, it may be determined whether a packet 324 that is pending delivery comprises a lower latency than the latency of the first packet 300.

The second link partner, 230b for example, may receive the second packet 324 prior to receiving one or more portions of the first packet, for example, the second portion of the first packet 326. In this regard, one or more of a PHY layer, a MAC layer and/or a higher OSI layer of the second link partner 230b, for example, may buffer the second packet 324 and/or the portions of the first packet 322 and/or 326. Moreover, one or more of the PHY layer, the MAC layer and/or the higher layers of the second of the link partner may parse the second packet 324 and/or the portions of the first packet 322 and/or 326 and/or may reconstruct data from the first packet 300 and/or data from the second packet 326. In various embodiments of the invention a third and/or more packets may preempt the second packet and/or the first packet.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for a method and system for packet preemption for low latency.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in an Ethernet network comprising link partners that are coupled via an Ethernet link, wherein one or more of said link partners comprises one or more PHY devices and one or more memory buffers:
determining latency requirements of one or more of a plurality of packets that are pending transmission;
interrupting transmission of a first packet of said plurality of packets comprising a latency requirement that is shorter than a latency requirement of a second packet of said plurality of packets that are pending transmission; and
transmitting said second packet from a first of said link partners to a second of said link partners, while said transmission of said first packet is interrupted.

2. The method according to claim 1, comprising inspecting OSI layer 2 or higher layer information within said one or more of said plurality of packets that are pending transmission to determine said latency requirements.

3. The method according to claim 1, comprising inspecting one or more marks within said one or more of said plurality of packets that are pending delivery to determine said latency requirements.

4. The method according to claim 1, comprising transmitting said second packet after transmission of a first portion of said first packet and/or prior to transmission of a second portion of said first packet.

5. The method according to claim 1, comprising inserting one or more delimiters among said first packet and/or said second packet for said interrupting of said transmission of said first packet.

6. The method according to claim 1, comprising determining whether a packet that is pending delivery comprises a shorter latency requirement than said latency requirement of said first packet prior to completion of transmission of said first packet.

7. The method according to claim 1, wherein said second of said link partners receives said second packet prior to receiving one or more portions of said first packet.

8. The method according to claim 7, wherein said second of said link partners buffers said second packet and/or said portions of said first packet.

9. The method according to claim 7, wherein one or more of said PHY layer, said MAC layer and/or said higher layer of said second of said link partners parses said second packet and/or said portions of said first packet.

10. The method according to claim 7, wherein one or more of said PHY layer, said MAC layer and/or said higher layer of said second of said link partners reconstructs data from said first packet and/or data from said second packet.

11. The method according to claim 1, comprising transmitting a third and/or more packets from said first of said link partners to said second of said link partners, while said transmission of said first packet, said second packet and/or more packets are interrupted.

12. The method according to claim 1, comprising determining whether said one or more link partners is configured to utilize packet preemption.

13. A system for communication, the system comprising:
one or more circuits for use in an Ethernet network comprising link partners that are coupled via an Ethernet link, said one or more circuits comprising one or more PHY devices and/or one or more memory buffers, wherein said one or more circuits are operable to:
determine latency requirements of one or more of a plurality of packets that are pending transmission;
interrupt transmission of a first packet of said plurality of packets comprising a latency requirement that is shorter than a latency requirement of a second packet of said plurality of packets that are pending transmission; and
transmit said second packet from a first of said link partners to a second of said link partners, while said transmission of said first packet is interrupted.

14. The system according to claim 13, wherein said one or more circuits are operable to inspect OSI layer 2 or higher layer information within said one or more of said plurality of packets that are pending transmission to determine said latency requirements.

15. The system according to claim 13, wherein said one or more circuits are operable to inspect one or more marks within said one or more of said plurality of packets that are pending delivery to determine said latency requirements.

16. The system according to claim 13, wherein said one or more circuits are operable to transmit said second packet after transmission of a first portion of said first packet and/or prior to transmission of a second portion of said first packet.

17. The system according to claim 13, wherein said one or more circuits are operable to insert one or more delimiters among said first packet and/or said second packet for said interrupting of said transmission of said first packet.

18. The system according to claim 13, wherein said one or more circuits are operable to determine whether a packet that is pending delivery comprises a shorter latency requirement than said latency requirement of said first packet prior to completion of transmission of said first packet.

19. The system according to claim 13, wherein said second of said link partners receives said second packet prior to receiving one or more portions of said first packet.

20. The system according to claim 19, wherein said second of said link partners buffers said second packet and/or said portions of said first packet.

21. The system according to claim 19, wherein one or more of said PHY layer, said MAC layer and/or said higher layer of said second of said link partners parses said second packet and/or said portions of said first packet.

22. The system according to claim 19, wherein one or more of said PHY layer, said MAC layer and/or said higher layer of said second of said link partners reconstructs data from said first packet and/or data from said second packet.

23. The system according to claim 13, wherein said one or more circuits are operable to transmit a third and/or more packets from said first of said link partners to said second of said link partners, while said transmission of said first packet, said second packet and/or more packets are interrupted.

24. The system according to claim 13, wherein said one or more circuits are operable to determine whether one or more of said link partners are configured to utilize packet preemption
